(19) United States
(12) Patent Application Publication
(10) Pub. No.: US 2026/0097354 A1
(43) Pub. Date: Apr. 9, 2026

(54) Gas Scrubber

(71) Applicant: Sendero Companies, LLC, Lubbock, TX (US)

(72) Inventors: Daniel Duke, Prosper, TX (US); Nikolay Spiridonov, Pittsburgh, PA (US)

(73) Assignee: Sendero Companies, LLC, Lubbock, TX (US)

(21) Appl. No.: 18/910,122

(22) Filed: Oct. 9, 2024

(51) Int. Cl. B01D 53/14; B01D 53/18

(52) U.S. Cl. CPC B01D 53/1412; B01D 53/185; B01D 2259/455

(57) ABSTRACT

Systems and methods for gas scrubbing. A gas scrubbing system includes a gas scrubbing chamber including a pressure sensor, a level safety high switch (LSH), and a level safety high high switch (LSHH). The system further includes a liquid pump connected to the gas scrubbing chamber that is in communication with the LSH, and an automatic control valve (ACV) coupled to an inlet for the gas scrubbing chamber. The ACV is in communication with the LSHH. The system also includes a gas compressor, or a vapor blower coupled to an outlet for the gas scrubbing chamber. The gas scrubbing system is disposed on a skid.

### BACKGROUND

### 1. Field of the Invention

The present application relates generally to systems and methods for gas scrubbing.

### 2. Description of Related Art

Gas scrubbing is well known in the art and is effective for separating fluids in various industries, including oil and gas. Typically, gas scrubbing systems are large on-site permanent installations. However, these permanent gas scrubbing installations have their shortcomings.

Some of the problems commonly associated with the permanently installed gas scrubbing systems are lengthy installation time, on-site space limitations, and high cost for the installation. Typical gas scrubbing systems include multiple separate components that occupy a substantial amount of space and require a substantial amount of time and resources to assemble and operate.

### DESCRIPTION OF THE DRAWINGS

The novel features believed characteristic of the invention are set forth in the appended claims. However, the invention itself, as well as a preferred mode of use, and further objectives and advantages thereof, will best be understood by reference to the following detailed description when read in conjunction with the accompanying drawings, wherein:

FIG. 1 is a front perspective view of a skid-mounted gas scrubbing system according to an embodiment of the present application;

FIG. 2 is a side view of the skid-mounted gas scrubbing system according to an embodiment of the present application;

FIG. 3 is a top view of the skid-mounted gas scrubbing system according to an embodiment of the present application; and

FIG. 4 is a top view operative schematic of the skid-mounted gas scrubbing system according to an embodiment of the present application.

While the system and method of use of the present application are susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

It is preferred that the systems and methods described herein are designed for gas scrubbing operations at a well site. As such, the systems and methods of the present application include a skid-mounted gas scrubbing system to facilitate deployment, installation, and removal. The skid-mounted gas scrubbing system is designed to plug into existing onsite infrastructure, having an inlet for an upstream connection and an outlet for a downstream connection. The skid-mounted gas scrubbing system may also include a vapor blower for flaring gas or a gas compressor for providing compressed gas to a pipeline. The portability of the skid-mounted gas scrubbing system and the inclusion of components on a single skid allows for plug and play gas scrubbing operations at well sites. It should be appreciated that alternative embodiments of the present application may be suitably adapted to a variety of gas scrubbing applications.

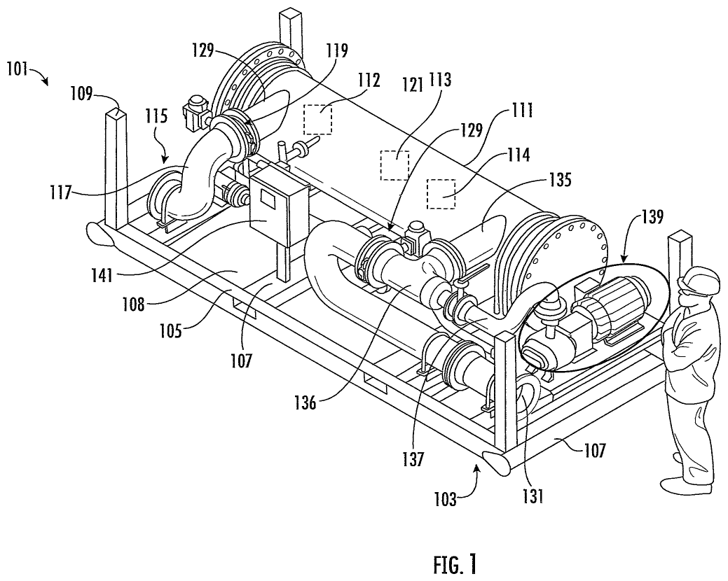

Referring now to FIG. 1, a front perspective view of a gas scrubbing system 101 is illustrated. The gas scrubbing system 101 includes a skid 103. The skid 103 may include metal components and includes members 105 extending lengthwise, members 107 extending laterally, and members 109 extending vertically. The members 107 extend laterally and couple to the members 105. The members 109 extend vertically and are coupled to corners of the skid 103. A platform 108 may be coupled to at least one member 107. Coupling of the members of the skid 103 may occur via welding, for example. A length of the members 105 may range from about 10 feet (ft) to about 15 ft. A length of the members 107 may range from about 5 ft to about 8 ft. A length of the members 109 may range from about 2.5 ft to about 5 ft.

The skid 103 includes a gas scrubbing chamber 111 extending lengthwise. The gas scrubbing chamber 111 may be of a cylindrical shape and may be coupled to at least one member 107. A length of the gas scrubbing chamber 111 may range from about 10 ft to about 15 ft. An ID of the gas scrubbing chamber 111 may range from about 20 ft to about 36 ft. The gas scrubbing chamber 111 may include internal components for separating liquids and gases within the gas scrubbing chamber 111.

The internal components may include a mist eliminator 112, a liquid distributor 113, and packing 114, for example. An inlet 115 to the gas scrubbing chamber 111 is disposed at a location upstream to the gas scrubbing chamber 111. A conduit 117 extends from the inlet 115 to the gas scrubbing chamber 111. An inner diameter (ID) of the conduit 117 may range from about 4 inches to about 12 inches. A length may range from about 4 ft to about 8 ft.

An automatic control valve (ACV) 119 is disposed in the conduit 117. The ACV 119 controls fluid flow into the gas scrubbing chamber 111. A conduit 120 extends from the gas scrubbing chamber 111 to the ACV 119. An ID of the conduit 120 may range from about 4 inches to about 8 inches. A length may range from about 0.5 inch to about 3 feet.

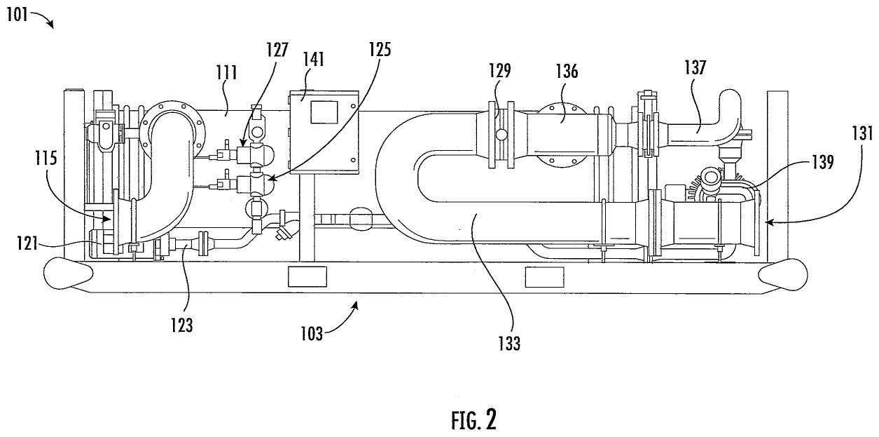

With additional reference to FIG. 2, a side view of the gas scrubbing system 101 illustrates a liquid pump 121 connected to a bottom portion of the gas scrubbing chamber 111. The liquid pump 121 pumps fluid out from the gas scrubbing chamber 111 via a conduit 123. An ID of the conduit 123 may range from about 0.5 inch to about 2 inches. A length may range from about 1 inch to about 5 ft.

A level safety high switch (“LSH 125”) and a level safety high high switch (“LSHH 127”) are in fluid communication with fluid in the gas scrubbing chamber 111. The LSH 125 is positioned below the LSHH 127 to detect a liquid level in the gas scrubbing chamber 111. The LSHH 127 is positioned above the LSH 125 to detect a liquid level in the gas scrubbing chamber 111.

The LSH 125 may detect liquid at a height/level ranging from about 6 inches to about 18 inches in the gas scrubbing chamber 111. The LSHH 127 may detect the liquid at a height/level ranging from about 8 inches to about 24 inches in the gas scrubbing chamber 111.

A second ACV (“ACV 129”) is disposed between the gas scrubbing chamber 111 and an outlet 131 for passing dry gas from the gas scrubbing chamber 111. A conduit 133 extends from the ACV 129 to the outlet 131. The inlet 115 and the outlet 131 are disposed on opposite ends of the skid 103. An ID of the conduit 133 may range from about 4 inches to about 12 inches. A length may range from about 2 feet to about 6 ft.

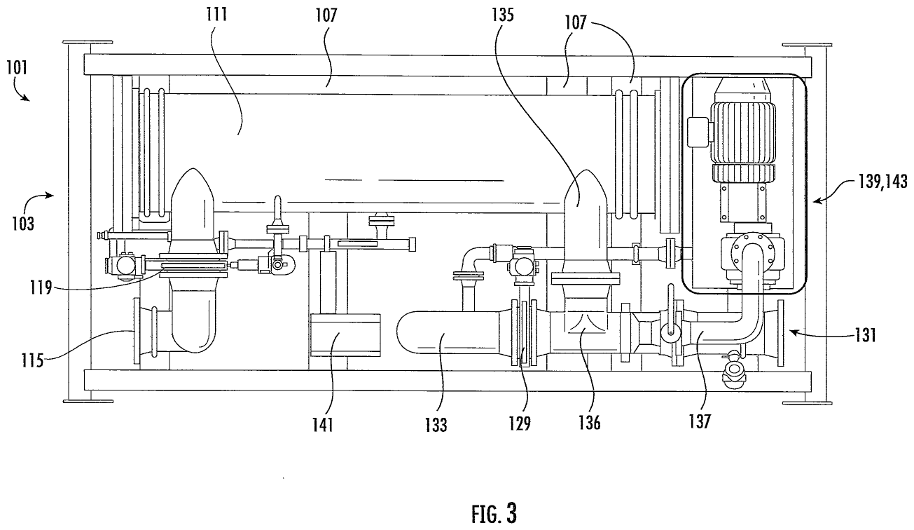

With additional reference to FIG. 3, a top view of the gas scrubbing system 101 illustrates a conduit 135 (i.e., an outlet for the chamber) extending from the gas scrubbing chamber 111 to a conduit 136. The conduit 136 is in fluid communication with the ACV 129 and a conduit 137. An ID of the conduit 135 may range from about 4 inches to about 12 inches. A length may range from about 0.5 inch to about 3 ft.

An ID of the conduit 136 may range from about 4 inches to about 12 inches. A length may range from about 1 ft to about 3 ft. An ID of the conduit 137 may range from about 4 inches to about 12 inches. A length may range from about 1 ft to about 6 ft. In some examples. Dry gas may flow from the gas scrubbing chamber 111 to either a vapor blower 139 or a gas compressor 143.

In a configuration with the vapor blower 139, the vapor blower 139 may be fluidly coupled to a combustion device for flaring the gas. The vapor blower 139 provides sufficient pressure and flow for flaring of the gas. In a configuration with the gas compressor 143, the gas compressor 143 may be in fluid communication with a pipeline and may provide compressed gas to the pipeline. The gas compressor 143 may be disposed at the outlet 131 and may be in fluid communication with the outlet 131. A junction box 141 supplies power to the gas scrubbing system 101. The junction box 141 may be coupled to a power source onsite (e.g., a generator).

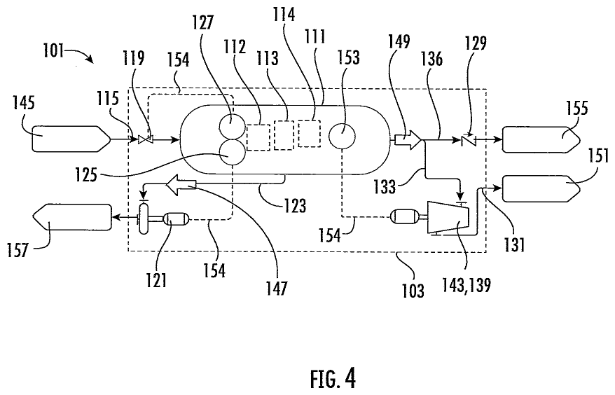

With additional reference to FIG. 4, an operative schematic of the gas scrubbing system 101 is illustrated. Wet gas and carry over liquid (“fluid 145”) enters the gas scrubbing chamber 111 via the inlet 115. If the LSHH 127 is clear (i.e., no detection of a liquid level in the chamber), the LSHH 127 signals the ACV 119 to stay open. As the wet gas passes through the gas scrubbing chamber 111, the internal components (e.g., mist eliminator 112, a liquid distributor 113, and packing 114) drop liquid 147 from the wet gas.

In the configuration with the gas compressor 143, dry gas 149 enters the gas compressor 143 and is compressed and passed through the outlet 131 (e.g., a compressed dry gas outlet) to a pipeline 151, for example. When pressure at the ACV 129 (or the pressure in the gas scrubbing chamber 111) is below an ACV-open pressure, the ACV 129 is closed and all of the dry gas 149 flows through the compressor 143 via the conduit 133. The speed (revolutions per minute (RPMs)) of the gas compressor 143 is based on pressure signals received from a pressure sensor 153 that is fluid communication with an internal volume of the chamber 111. Communication lines 154 (e.g., electrical lines) allow for transmission and receiving of signals. The compressor speed may increase due to high pressure in the gas scrubbing chamber 111 and may decrease due to low pressure. Low pressure may range from about 0.1 psi to about 275 pounds per square inch (psi). High pressure may range from about 275 psi to 1440 psi.

In the configuration with the vapor blower 139, when the pressure at the ACV 129 (or the pressure in the gas scrubbing chamber 111) exceeds the ACV-open pressure, the ACV 129 is open and all of the gas flows to the vapor blower 139. The vapor blower 139 may be fluidly coupled (e.g., fluid communication) to a combustion device 155 for flaring or a vent line. When the pressure falls below a set ACV open pressure (i.e., a threshold pressure), the ACV 129 closes.

Values for the threshold pressure for the ACV 129 range from about 0.1 psi to about 275 psi. Usage of the compressor 143 or the vapor blower 139 reduces pressure and maintains a lower pressure in the gas scrubbing chamber 111. This increases the velocity of the gas and the gas volume flowing from equipment upstream of the gas scrubbing chamber 111 into the gas scrubbing chamber 111. Usage of the compressor 143 or the vapor blower 139 also reduces and maintains lower pressure in the gas scrubbing chamber 111 which increases liquid dropout from the wet gas. Usage of the compressor 143 or the vapor blower 139 also increases and maintains higher downstream pressure to allow unloading of the gas into the pipeline. Usage of the compressor 143 or the vapor blower 139 also increases and maintains higher downstream pressure which increases velocity of the gas and allows for a cleaner burn at the flare.

When accumulated liquid (e.g., gas condensate and carry-over liquid) in the gas scrubbing chamber 111 is detected by the LSH 125, the LSH 125 starts the pump 121 to unload the accumulated liquid (i.e., the liquid 147) out of the gas scrubbing chamber 111 via the conduit 123. The liquid 147 may be pumped out through a condensate outlet 157. When the accumulated liquid (i.e., the gas condensate and carry-over liquid) in the gas scrubbing chamber 111 is detected by the LSHH 127, the LSHH 127 closes the ACV 119. The ACV 119 remains closed until the accumulated liquid level in the gas scrubbing chamber 111 is not detected by the LSHH 127. The ACV 119 may open when the accumulated liquid level in the gas scrubbing chamber 111 is not detected by the LSHH 127.

It is apparent that an invention with significant advantages has been described and illustrated. Although the present application is shown in a limited number of forms, it is not limited to just these forms, but is amenable to various changes and modifications without departing from the spirit thereof.

What is claimed is:

1. A system comprising:
a gas scrubbing chamber including:
a pressure sensor;
a level safety high switch (LSH); and
a level safety high high switch (LSHH);
a liquid pump connected to the gas scrubbing chamber, the liquid pump in communication with the LSH;
an automatic control valve (ACV) coupled to an inlet for the gas scrubbing chamber, the ACV in communication with the LSHH;
a gas compressor or a vapor blower coupled to an outlet for the gas scrubbing chamber, wherein the gas compressor is in communication with the pressure sensor;
a second ACV in fluid communication with the gas compressor or the vapor blower; and
wherein the gas scrubbing chamber, the liquid pump, the ACV, the gas compressor or the vapor blower, and the second ACV are disposed on a skid.

2. The system according to claim 1, wherein the gas scrubbing chamber extends lengthwise on the skid.

3. The system according to claim 1, wherein the ACV is configured to open or close based upon the liquid level detected by the LSHH.

4. The system according to claim 1, wherein the liquid pump is configured to pump accumulated liquid in the gas scrubbing chamber based upon the liquid level detected by the LSH.

5. The system according to claim 1, wherein the second ACV is configured to open when a pressure at the second ACV exceeds a threshold.

6. The system according to claim 1, wherein the second ACV is configured to close when a pressure at the second ACV is below a threshold.

7. The system according to claim 6, wherein the gas compressor is configured to compress gas when the second ACV is closed.

8. The system according to claim 1, wherein a speed of the gas compressor is based on pressure in the gas scrubbing chamber.

9. The system according to claim 1, further including a compressed gas outlet coupled to the compressor.

10. The system according to claim 1, further including a gas condensate outlet coupled to the liquid pump.

11. A method comprising:
controlling flow of a fluid into a chamber of a gas scrubbing system with an automatic control valve (ACV) that is in communication with a level switch high-high (LSHH), wherein the fluid includes a wet gas and a carry-over liquid;
passing the wet gas through the chamber to remove liquid from the wet gas to provide dry gas;
directing flow of the dry gas to a compressor or a vapor blower; with a second ACV; and
compressing the dry gas or moving the dry gas with the vapor blower, wherein the chamber, the ACV, the compressor or the vapor blower, and the second ACV are disposed on a skid, wherein the chamber extends lengthwise on the skid.

12. The method of claim 11, wherein controlling the flow of the dry gas includes opening the second ACV when a pressure at the second ACV exceeds a threshold pressure; and directing the dry gas to an outlet.

13. The method of claim 12, wherein the outlet is in fluid communication with the vapor blower or the compressor.

14. The method of claim 11, wherein controlling the flow of the dry gas includes closing the second ACV when a pressure at the second ACV is below a threshold pressure; and directing the dry gas to the compressor.

15. The method of claim 11, further comprising pumping accumulated liquid from the chamber when a liquid level reaches a level safety high switch (LSH), wherein the LSH is disposed in the chamber.

16. The method of claim 11, wherein controlling the flow of the fluid into the chamber further comprises closing the ACV when a liquid level in the chamber reaches the LSHH.

17. The method of claim 11, wherein controlling the flow of the fluid into the chamber further comprises opening the ACV when a liquid level in the chamber is below the LSHH.

18. The method of claim 11, wherein the LSHH is disposed in the chamber.

19. The method of claim 11, wherein revolutions per minute of the compressor are based on pressure in the chamber.

20. The method of claim 11, wherein the chamber includes a pressure sensor that is in communication with the compressor.
